(19) United States
(12) Patent Application Publication
(10) Pub. No.: US 2025/0131843 A1
(43) Pub. Date: Apr. 24, 2025

(54) IN-CONTEXT EXPLORATORY LANGUAGE LEARNING APPARATUS AND METHOD

(71) Applicant: MIRINAE TECHNOLOGIES INC., Seoul (KR)

(72) Inventors: Hwan Soo YOO, Seoul (KR); John WAINWRIGHT, Campbell, CA (US)

(21) Appl. No.: 17/909,502

(22) PCT Filed: Mar. 8, 2021
(86) PCT No.: PCT/KR2021/002854

§ 371 Date: Sep. 6, 2022

Related U.S. Application Data
(60) Provisional application No. 62/986,764, filed on Mar. 8, 2020.

(30) Foreign Application Priority Data
Oct. 21, 2020 (KR) 10-2020-0137118

(51) Int. Cl. G09B 5/06; G06F 9/54; G06Q 50/20

(52) U.S. Cl. CPC G09B 5/065; G06F 9/547; G06Q 50/20

(57) ABSTRACT

An in-context exploratory language learning apparatus includes a browser means for searching for and playing the video according to the user's request; an adapter means for matching and applying the image searched and reproduced by the browser means with text; a function providing means for providing language, search, and service-content; a service API (Application Program Interface) that provides investigation, analysis, storage, and return functions according to the user's request; a service adapter means for providing learning and reference service functions; an external computer server that provides learning and reference services through wired or wireless communication networks, so that users can learn a specific language when playing video and learn words during learning.

### CROSS REFERENCE

This is a PCT national stage entry of International Application No. PCT/KR2021/002854 claiming priority of U.S. Provisional Application No. 62/986,764 and Korean Patent Application No. 10-2020-0137118, the entirety of which is incorporated herein by reference.

### BACKGROUND

The present invention relates to an in-context exploratory language learning apparatus and the method thereof, and more particularly, to an in-context exploratory language learning apparatus and the method thereof, which augment certain kinds of computer-based, content-directed language learning, exploration & reference systems so that they can be used in novel and more effective ways.

With the development of Internet services, the number of people who enjoy video content from other countries using personal terminals or electronic devices is increasing.

In particular, under the influence of K (Korean)-pop, in English-speaking countries, not only Korean music videos but also various video contents such as movies are increasingly being watched.

However, for example, when watching a Korean video using a video viewing program such as Viki, which uses English, learning Korean serviced through subtitles or trying to find the English of the corresponding Korean, there is no immediate service available. the current situation.

Prior Art Document: Korean Patent Publication No. 10-1578991 (registered on Dec. 14, 2015).

### SUMMARY OF THE INVENTION

In consideration of the above-mentioned circumstances, it is an object of the present invention to provide an in-context exploratory language learning apparatus and the method thereof, which augment certain kinds of computer-based, content-directed language learning, exploration & reference systems so that they can be used in novel and more effective ways.

To achieve the above object, according to an aspect of the present invention, there is provided an in-context exploratory language learning apparatus, which comprises a browser means for searching for and playing the video according to the user's request; an adapter means for matching and applying the image searched and reproduced by the browser means with text; a function providing means for providing language, search, and service-content; a service API (Application Program Interface) that provides investigation, analysis, storage, and return functions according to the user's request; a service adapter means for providing learning and reference service functions; an external computer server that provides learning and reference services through wired or wireless communication networks, so that users can learn a specific language when playing video and learn words during learning.

As described above, in accordance with an in-context exploratory language learning apparatus and the method thereof, unlike the existing content-based language learning system, by expanding the content-oriented language learning, search and reference system, a computer-based language learning system can be provided new and more effectively.

It results in an in-context exploratory language learning system that allows organically-encountered instances of a language being learned to be explored and learned about in-situ, without having to leave the current media context.

This, in turn, provides a fluid, low-friction opportunity for bottom-up language learning, augmenting the conventional, structured top-down approaches currently in wide use.

To achieve the above object, according to an aspect of the present invention, there is provided an in-context exploratory language learning apparatus, which comprises a browser means for searching for and playing the video according to the user's request; an adapter means for matching and applying the image searched and reproduced by the browser means with text; a function providing means for providing language, search, and service-content; a service API (Application Program Interface) that provides investigation, analysis, storage, and return functions according to the user's request; a service adapter means for providing learning and reference service functions; an external computer server that provides learning and reference services through wired or wireless communication networks, so that users can learn a specific language when playing video and learn words during learning.

In accordance with another aspect of the present invention, there is provided an in-context exploratory language learning method, which comprises a first step of receiving a learning request signal for a Korean language that the user wants to better understand or explore while the user is watching Korean drama content on a specific streaming site that provides Korean subtitles;
a second step of displaying Korean sentences according to the user's request and displaying and presenting other languages according to the corresponding forms, a third step of receiving a request signal to find a
Korean instance in the current content through the learning extension program from the user, and
a fourth step of outputting a screen displaying an exemplary sentence pattern according to a user's request.

In addition, wherein the fourth step can be performed through a menu or another activation device provided by an extension program, or automatically when the user pauses video playback.

In addition, wherein the extension program visually displays all candidate instances of Korean.

### BRIEF DESCRIPTION OF DRAWINGS

FIG. 1 is a schematic system configuration diagram of an in-context exploratory language learning apparatus according to the present invention.

FIG. 2 is a view showing a playback screen, a learning screen, and a function screen exemplarily showing the learning process of the in-context exploratory language learning apparatus according to the present invention.

FIG. 3 is a view showing a playback screen and a learning screen exemplarily showing the learning process of the in-context exploratory language learning apparatus according to the present invention.

FIG. 4 is a block diagram for explaining a schematic configuration of an in-context exploratory language learning apparatus according to the present invention.

### DETAILED DESCRIPTION OF THE INVENTION

Hereinafter, an in-context exploratory language learning apparatus and the method thereof according to the present invention will be described in detail with reference to the accompanying drawings.

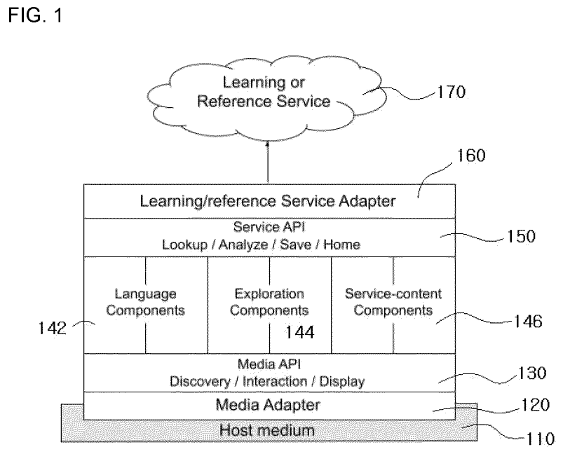

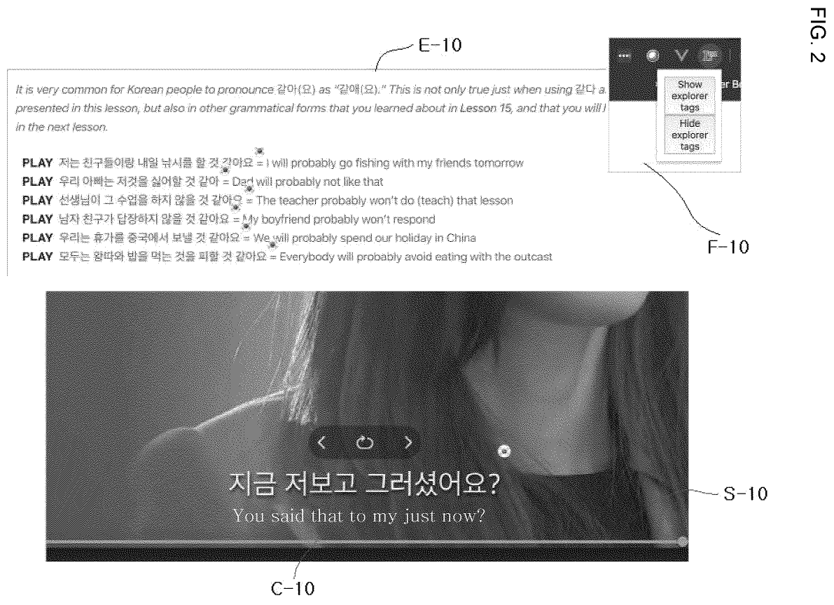

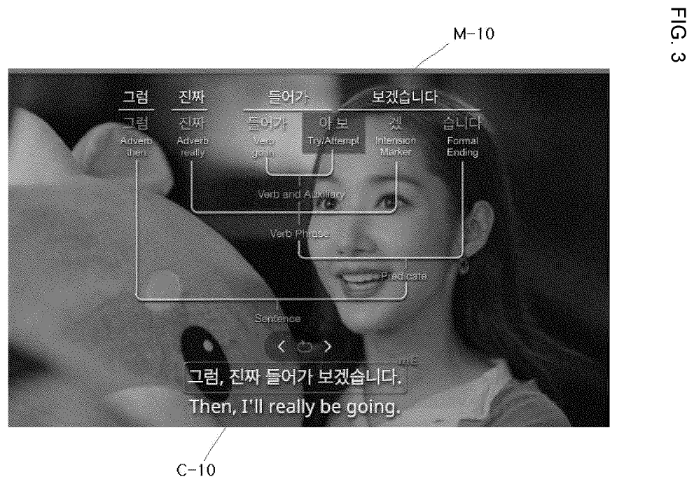

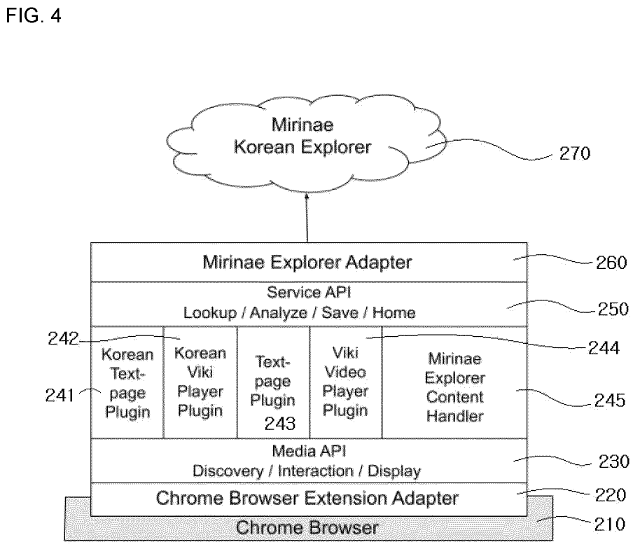

FIG. 1 is a schematic system configuration diagram of an in-context exploratory language learning apparatus according to the present invention, FIG. 2 is a view showing a playback screen, a learning screen, and a function screen exemplarily showing the learning process of the in-context exploratory language learning apparatus according to the present invention, FIG. 3 is a view showing a playback screen and a learning screen exemplarily showing the learning process of the in-context exploratory language learning apparatus according to the present invention, and FIG. 4 is a block diagram for explaining a schematic configuration of an in-context exploratory language learning apparatus according to the present invention.

As shown in FIG. 1, the present invention encompasses methods and apparatus for finding instances of the language being learned (target language) within the media being currently experienced, UIX devices for offering exploration and learning opportunities and display of the reference or teaching material from the connected system, along with a plugin-based extensibility framework for adding new languages, media-contexts & learning-systems and API (Application Program Interface) designs for integrating the in-context language-exploration system and content-drive learning systems it augments.

### System Design

One embodiment of this invention is shown below; other embodiments are possible as described in the embodiments section below, including those that do not have the same generalized & extensible architecture.

The above embodiment is a generalized design employing several standardized APIs implemented by adapters for specific host mediums 110 and learning services and a set of components, possibly implemented as plugins, for various target languages, interaction modes and display styles that use those APIs to provide the in-context learning experience.

A specific embodiment of this invention for a particular target language and exploratory learning service is shown in a later section of this invention.

The key components are as follows:
A host medium in which some content is being experienced, such as a web browser page, streaming video player, smart TV, mobile app, audio player, etc.
An optional media adapter that implements a standardized set of media-side APIs allowing various common plugins to be used without change in different media contexts. For example, adapters for the Chrome & Safari browser extension schemes would allow a set of common plugins to be used in both browsers.

The Media API services 130 proposed in this embodiment include:
Discovery, providing discovery services for finding and labeling instances of the target language in the current media. This might only operate when the media is in some state, such as a video with subtitling in the target language being put into a paused state by the user. The adapter, in some cases, may do media conversions, such as optical-character recognition on video frames, or speech-to-text on audio segments, in order to get content in a form acceptable by the learning service.
Interaction, providing interactive services, such as allowing the user to select a content item & send it for analysis, or navigating the returned reference & learning material.
Display, providing services to display the learning & reference material returned from the learning service.

Embodiments of this invention that do not include a media adapter will plugins that are built specifically for each host medium, but will otherwise provide the same in-context learning services as those with an adapter; the adapter is essentially an implementation optimization.
An optional learning service adapter that implements a standard service-side API for common plugins to interact with different learning or reference services.

Such services include word-definition dictionaries, text translation services, pronunciation guides, idiom libraries, and exploratory language-learning services. The service-bound API provides services for submitting content for lookup, analysis or other processing, polling the service for and retrieving the results, possibly incrementally supplied, result display and navigation, saving content in or visiting home sites for the service, etc.

As with the media-side adapter, if the service adapter is not implemented in any embodiment, the plugins will be specialized to directly interact with each learning or reference service.
A set of plugins or components that implement variations of the in-context service along a number of dimensions. For example:
The language components 142 each implement processes related to different target languages, such as filtering candidate text coming from the discovery API for conformant instances of the target language, or breaking it into serviceable chunks, and so on.
The exploration components 144 implement different exploration modes that can accommodate the nature of the in-context content structures and the kinds of reference or learning service provided. For example, content comprised typically of large blocks of the target language when used with a word-definition service may require an exploration mode that supports easy selection & navigation of single words, or a song-lyric translation service may be best supported by in-context exploration modes that help find lyric stanzas or navigate typical lyric display styles.
The service content components 146 handle the various kinds of learning or reference service material returned by the exploration request. Simple word-definition or sentence-translation services require simple display modes, whereas an exploratory learning service may present layers of reference material that can itself be explored and navigated in-situ.

Unexplained reference numerals indicate the service API 150 and the learning/referencing service adapter 160. It may be connected through a wired/wireless communication network 170 for a link operation with a wired/wireless communication network or an external server (not shown) that provides a learning or reference service.

As mentioned above, other embodiments of this invention may not use some or any adapters, standard APIs, or plugins in their implementation, but still achieve the same purpose of in-context learning or exploration, as outlined in the principle of operation section below.

### Principles of Operation

The essential function of this invention is to provide an interactive, in-media opportunity to explore & study organically-encountered instances of a language being learned. The following description of one embodiment of this invention exemplifies this function. Other embodiments may work with alternate learning or reference services, work in different media contexts, support other languages, but otherwise perform the same form of in-context learning service.

### Browser-Based Exploratory Learning of Korean on Text Web-Pages and the “Viki” Drama-Streaming Site

This example of the invention integrates with an exploratory learning service, such as the “Mirinae” Korean Language Explorer, and comprises the following components. Since FIG. 4 has a configuration similar to that of FIG. 1, it will be mainly described with reference to parts different from those of FIG. 1.

Referring to FIG. 4, it has a configuration similar to that of FIG. 1, and includes a Chrome browser 210, a “Mirinae” API (discovery/interaction/display) 230, a Korean text page plug-in 241, and a Korean VIKI player plug-in 242, a text page plug-in 243, a non-key video player plug-in 244, and a “Mirinae” Explorer content handler (Handler) 245,
a service API 240 and a “Mirinae” Explorer adapter 260, and a wired/wireless communication network or (Mirinae) Korean Explorer 270 for connection with an external server.
A Chrome browser-extension adapter that allows the other components listed here to be installed and run as a browser extension on websites of the user's choice and provides DOM discovery, interaction and display services.

Other embodiments would embed the following components directly in those websites wishing to implement direct integration with a learning service, bypassing the need to use browser-extension mechanisms.
A Korean language component that can discover and mark instances of Korean text in a text-based web page, such as would be encountered on courseware, cooking, culture and other such sites.
A Korean language component that is specialized for the Viki drama streaming site, capable of recognizing the video player controls, play state and finding and marking any Korean subtitles.
An exploration component connected to Korean content found & marked by the above components that will respond to exploration requests by the user, gather & format the text to be explored and send it to the “Mirinae” Explorer service.
A result retrieval, display and navigation component that handles learning content responses from the “Mirinae” Explorer service and provides interactive display of that content, usually in the form of temporary overlay over the regular page contents. This component also supports saving explored context back to the “Mirinae” service for later continued study and links to that service hmie site and any other relevant reference services.
A “Mirinae” service adapter that provides general connection services to the “Mirinae” APIs for the other components. In some embodiments, the components may connect directly to the reference or learning service.

### Typical Operation

The following assumes the learning browser extension is installed and enabled for the websites of interest.

As the user browses various sites, he or she may encounter a page containing instances of the language being learned, Korean text, in this case. This might be example sentences on a Korean courseware site, song lyrics on a K-Pop site, or chat messages on a language-exchange site.

Alternatively, the user may be watching a Korean drama on a streaming site such as viki.com that provides optional Korean subtitles (refers to FIG. 2 or FIG. 3).

While consuming this content, the user encounters some Korean that he or she would like to understand better or otherwise explore. (Korean subtitles C-10 English subtitles are selectively displayed. M-10 in FIG. 3 indicates subtitles for learning or reference that are classified into verbs, adjectives, phrases, sentences, subjects, and predicates representing the characteristics of the present invention).

If this is a subtitle on a video, the user might pause the video to allow further study.

The user engages the learning extension, requesting that it find instances of Korean in the current content.

This could be through a menu or other activating device provided by the extension, or be done automatically, say when the user pauses video playback. The extension marks all the candidate instances of Korean in some visible form. Refer to Figures and explanations below.

The accompanying Figures show how the browser extension has found and tagged the instances of Korean available for exploration with small Korean-flag buttons. The top-right image shows one possible activation embodiment, an extension pop-up menu offering buttons to show or hide the exploration tags.

The video image shows the player in pause mode, with the Korean subtitle similarly tagged with an explorer button.

In both kinds of content, a browser-extension content script traverses the page DOM (Document Object Model) for conformant instances of Korean text and augments the DOM at those locations with the explorer-tag button HTML and event-handler scripts.

The user launches an exploration by clicking the tag button. This activates the exploration component which may marshal some already loaded reference content or extract and prepare the associated Korean text and invoke an asynchronous request to the learning service, such as the “Mirinae” Explorer in-context service API.

The learning material or reference overlay may also include controls to allow the current exploration context to be saved to the attached learning service for later review, as well as links to move the exploration over to the home site for the service, usually by navigating the browser to that home site (refers to FIG. 3).

Other controls will dismiss the overlay and allow the user to continue browser or viewing the content. A block diagram showing the main components in the above example will be shown by accompanying Figures.

This invention has been described in its presently contemplated best mode, and it is clear that it is susceptible to numerous modifications, modes and embodiments within the ability of those skilled in the art and without the exercise of the inventive faculty. Accordingly, the scope of this invention is defined by the scope of the following claims.

### INDUSTRIAL APPLICABILITY

As described above, in accordance with the method for As described above, in accordance with an in-context exploratory language learning apparatus and the method thereof, unlike the existing content-based language learning system, by expanding the content-oriented language learning, search and reference system, a computer-based language learning system can be provided new and more effectively.

It results in an in-context exploratory language learning system that allows organically-encountered instances of a language being learned to be explored and learned about in-situ, without having to leave the current media context.

This, in turn, provides a fluid, low-friction opportunity for bottom-up language learning, augmenting the conventional, structured top-down approaches currently in wide use.

1. An in-context exploratory language learning apparatus comprising:
a browser means for searching for and playing the video according to the user's request;
an adapter means for matching and applying the image searched and reproduced by the browser means with text;
a function providing means for providing language, search, and service-content;
a service API (Application Program Interface) that provides investigation, analysis, storage, and return functions according to the user's request;
a service adapter means for providing learning and reference service functions;
an external computer server that provides learning and reference services through wired or wireless communication networks, so that users can learn a specific language when playing video and learn words during learning.

2. An in-context exploratory language learning method comprising:
a first step of receiving a learning request signal for a Korean language that the user wants to better understand or explore while the user is watching Korean drama content on a specific streaming site that provides Korean subtitles;
a second step of displaying Korean sentences according to the user's request and displaying and presenting other languages according to the corresponding forms,
a third step of receiving a request signal to find a Korean instance in the current content through the learning extension program from the user, and
a fourth step of outputting a screen displaying an exemplary sentence pattern according to a user's request.

3. The in-context exploratory language learning method according to claim 2, wherein the fourth step can be performed through a menu or another activation device provided by an extension program, or automatically when the user pauses video playback.

4. The in-context exploratory language learning method according to claim 2, wherein the extension program visually displays all candidate instances of Korean.
